(19) United States
(12) Patent Application Publication
(10) Pub. No.: US 2024/0020123 A1
(43) Pub. Date: Jan. 18, 2024

(54) PROCESSOR AND DATA OPERATION METHOD THEREOF

(71) Applicant: ALIBABA (CHINA) CO., LTD., ZHEJIANG PROVINCE (CN)

(72) Inventors: YANHENG LU, SHANGHAI (CN); YEN-KUANG CHEN, PALO ALTO, CA (US)

(21) Appl. No.: 18/322,275

(22) Filed: May 23, 2023

(30) Foreign Application Priority Data
Jul. 18, 2022 (CN) 202210839981.3

(51) Int. Cl. G06F 9/30

(52) U.S. Cl. CPC G06F 9/30098

(57) ABSTRACT

The present application discloses a processor and a data operation method thereof. The processor includes: a first set of registers, a second set of registers and an execution unit. The execution unit is electrically connected to the first set of registers and the second set of registers, and configured to: convert data stored in the first set of registers from a first bit unit to a second bit unit, wherein the number of bits of the first bit unit is less than the number of bits of the second bit unit and the number of bits of the second bit unit is not an integer multiple of the number of bits of the first bit unit; and store the data in the second set of registers, wherein the number of registers of the second set of registers is greater than the number of registers of the first set of registers.

### CROSS-REFERENCE TO RELATED APPLICATIONS

This application claims priority to China Application Serial Number 202210839981.3, filed on Jul. 18, 2022, which is incorporated by reference in its entirety.

### TECHNICAL FIELD

The present disclosure relates to a processor and a data operation method thereof and, more particularly, to a processor that converts data in a lower bit unit to data in a higher bit unit, and a data operation method thereof.

### BACKGROUND

The number of applications of video image data continues to grow, and users also have increasingly higher requirements for video image quality. Depth video images in a conventional low number of bits (such as 8 bits) no longer satisfies user requirements, and thus video techniques of depth video images in a higher number of bits (for example, 10 bits or 12 bits) are currently developing rapidly. However, instruction extensions of conventional multimedia (for example, video images) exist only in two unsigned fixed-point data types, that is, 8-bit and 16-bit forms. When the video image depth is increased from 8 bits to 10 bits or 12 bits, the conventional instructions associated with these two data types encounter certain obvious issues.

More specifically, for an operation of unsigned fixed-point single instruction multiple data (SIMD), once the data bandwidth is increased (for example, to 10 bits or 12 bits), it is apparent that the associated instructions fail to directly provide corresponding support. If the high-bit processing is directly reduced to low-bit processing, enhanced image quality contributed by the high number of bits cannot be presented. Moreover, for an operation of a 16-bit unsigned fixed-point instruction, 10 bits or 12 bits can indeed be implemented by the representation in 16 bits. However, there are then the following issues: (1) there is a redundancy of at least 6 bits or 4 bits; and (2) in a 16-bit space, only low 10 bits or 12 bits are valid, and the computation ability of hardware is wasted in terms of computation efficiency.

### SUMMARY

A data operation method for a processor is provided according to an embodiment of the present application. The data operation method includes: converting data stored in a first set of registers from a first bit unit to a second bit unit, wherein the number of bits of the first bit unit is less than the number of bits of the second bit unit and the number of bits of the second bit unit is not an integer multiple of the number of bits of the first bit unit; and storing the data in the second set of registers, wherein the number of registers of the second set of registers is greater than the number of registers of the first set of registers.

A processor is further provided according to another embodiment of the present application. The processor includes a first set of registers, a second set of registers and an execution unit. The execution unit is electrically connected to the first set of registers and the second set of registers, and configured to: convert data stored in the first set of registers from a first bit unit to a second bit unit, wherein the number of bits of the first bit unit is less than the number of bits of the second bit unit and the number of bits of the second bit unit is not an integer multiple of the number of bits of the first bit unit; and store the data in the second set of registers, wherein the number of registers of the second set of registers is greater than the number of registers of the first set of registers.

A processor is further provided according to yet another embodiment of the present application. The processor includes an execution unit, and is configured to execute at least one computer instruction of an instruction set to perform arithmetic calculations or logic operations on data in a first set of registers, wherein the data in the first set of registers is stored in a first bit unit, and execute a plurality of conversion instructions of the instruction set to convert data in a second set of registers from the first bit unit to a second bit unit; wherein, the first bit unit includes 10 bits, 12 bits or 14 bits.

The processor and the data operation method thereof of the present application are capable of converting data in a low bit unit to a data in a high bit unit, wherein the number of bits of the high bit unit is not an integer multiple of the number of bits of the low bit unit. Thus, in addition to providing instruction extensions with better calculation efficiency for video images, wastes in hardware space or computation ability can be at the same time prevented.

### BRIEF DESCRIPTION OF THE DRAWINGS

Aspects of the present disclosure can be better understood by reading the following embodiments in combination with the accompanying drawings below. It should be noted that, according to standard practice in industry, the various structures in the drawings are not drawn to scales. In fact, for description clarity, the sizes of the various structures may be increased or reduced as desired.

FIG. 1 is a block diagram of a processor according to an embodiment;

FIG. 2A to FIG. 2D are schematic diagrams of examples of data conversion and storage operations according to an embodiment;

FIG. 3A to FIG. 3E are schematic diagrams of examples of data conversion and storage operations according to an embodiment; and

FIG. 4 is a flowchart of a data operation method according to an embodiment.

### DETAILED DESCRIPTION

The disclosure below provides various different embodiments or examples of different components used to implement the subject matter of the disclosure. Specific examples of components and configurations are given in the description below to simplify the present disclosure. However, such descriptions are merely examples and are not intended to be restrictive. For example, in the description below, a first component formed on or above a second component may include an embodiment in which the first component and the second component are formed in a direct contact manner, and may further include an embodiment in which an additional component is formed between the first component and the second component in a way that the first component and the second component are in indirect contact. Moreover, reference numerals and/or alphabetical symbols may be repeated in the various embodiments of the present disclosure. Such repetition is for the sake of brevity and clarity and does not indicate relations of the various embodiments and/or configurations discussed herein.

Moreover, for better description, for example, relative spatial terms such as “below”, “beneath”, “under”, “above”, “on top of” and “over” and the like may be used to describe a relation of one element or component with respect to another element or component illustrated in the drawings. In addition to the orientation depicted in the drawings, the relative spatial terms are intended to cover different orientations of a device in use or in operation. An apparatus may be orientated by other means (rotated by 90 degrees or having another orientation), and descriptive relative spatial terms used herein may also be similarly and correspondingly interpreted.

For example, terms herein such as “first”, “second” and “third” are used to describe various elements, components, areas, layers and/or sections, it should be noted that these elements, components, areas, layers and/or sections are not to be limited by such terms. Such terms are used to differentiate one element, component, area, layer or section from another. For example, the terms “first”, “second” and “third” used herein do not imply a sequence or order, unless otherwise specified in the contents of the background.

The singular form “a”, “one” and “the” may include the plural form, unless otherwise specified in the context. The term “connect/couple” and its derivatives are used to describe structural relations of parts herein. The term “connect/couple” may be used to describe that two or more elements are in direct physical or electrical contact with each other. The term “connect/couple” may be used to indicate that two or more elements are in direct or indirect (with an intermediate element in between) physical or electrical contact with each other, and/or these two or more elements coordinate or interact with each other.

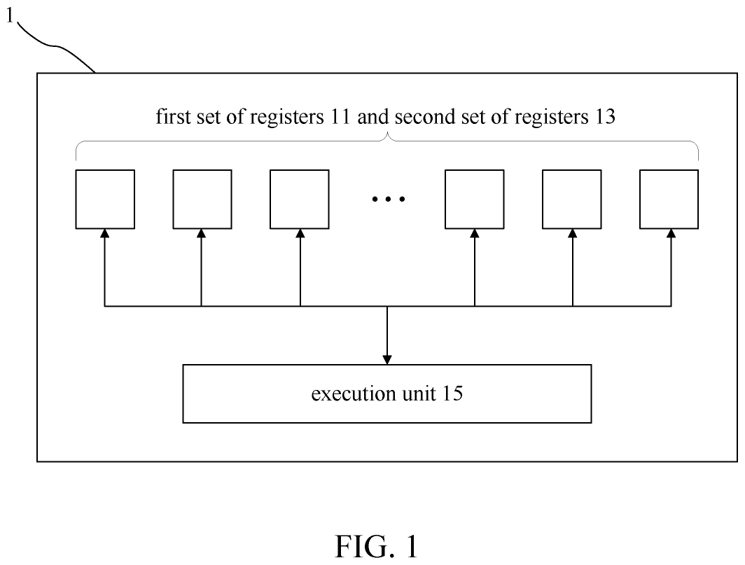

FIG. 1 shows a block diagram of a processor 1 according to an embodiment of the present application. The processor 1 includes a first set of registers 11, a second set of registers 13 and an execution unit 15. The execution unit 15 is coupled/electrically connected to the first set of registers 11 and the second set of registers 13. Data and signals are transmitted among the components through electrical connections. Associated operation details are to be given in the description below.

In some embodiments, data in a first bit unit are stored in the first set of registers 11, and the execution unit 15 converts the data stored in the first set of registers 11 from the first bit unit to a second bit unit. In these embodiments, the number of bits of the first bit unit is less than the number of bits of the second bit unit. In other words, the first bit unit is a lower bit unit, and the second bit unit is a higher bit unit. Moreover, the number of bits of the second bit unit is not an integer multiple of the number of bits of the first bit unit. In other words, a value obtained by dividing the number of bits of the second bit unit by the number of bits of the first bit unit is not an integer.

For example, the first bit unit includes 8 bits, 10 bits, 12 bits or 14 bits, the second bit unit includes 10 bits, 12 bits, 14 bits, 16 bits, 32 bits or 64 bits, and the relationship between the first bit unit and the second bit unit satisfies: (1) the number of bits of the first bit unit is less than the number of bits of the second bit unit; and (2) the number of bits of the second bit unit is not an integer multiple of the number of bits of the first bit unit.

Next, the execution unit 15 stores the converted data in the second set of registers 13. Since the data have been converted from a low bit unit to a high bit unit, the number of registers of the second set of registers 13 has to be greater than the number of registers of the first set of registers 11. For example, when the first set of registers 11 store N data in a 12-bit unit, the total amount of data is N*12 bits=12N bits. Once each of the N data has been converted from a 12-bit unit to a 16-bit unit, the total amount of data is N*16 bits=16N bits. Thus, there are additional 4N bits of data after the conversion, and theoretically more registers are needed. Conversion and storage processes are described by way of various examples below.

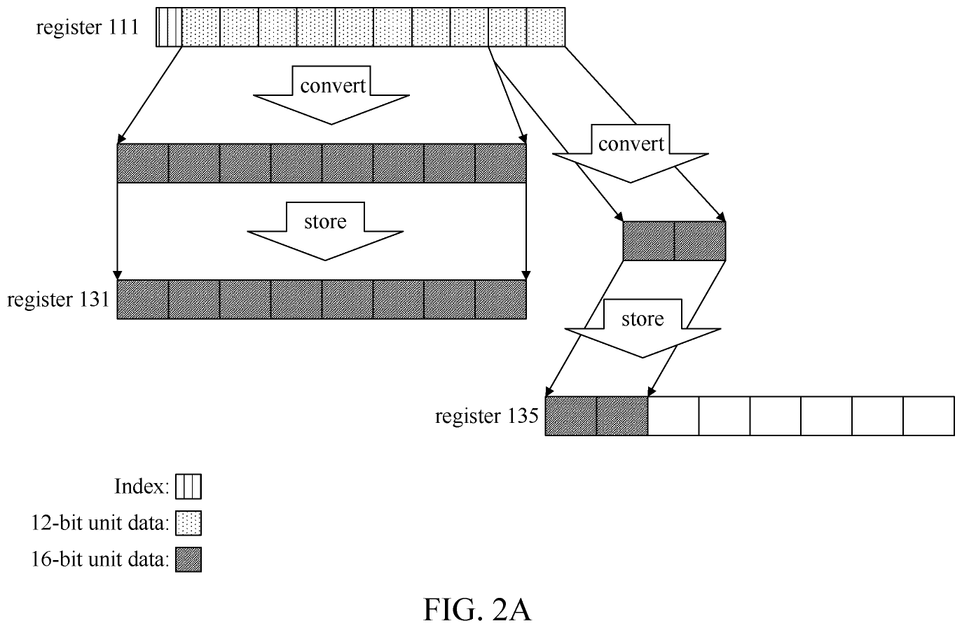

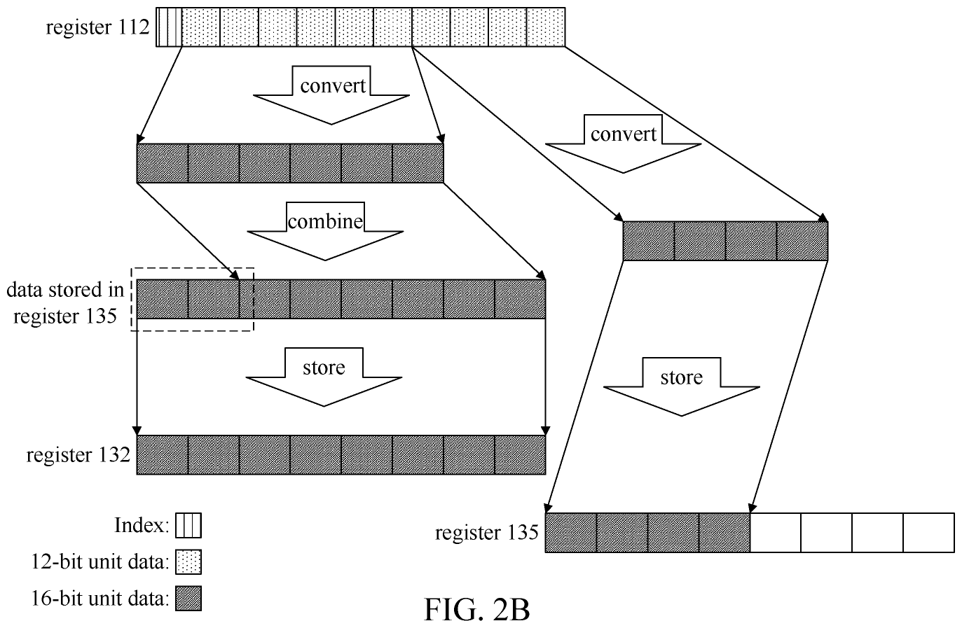

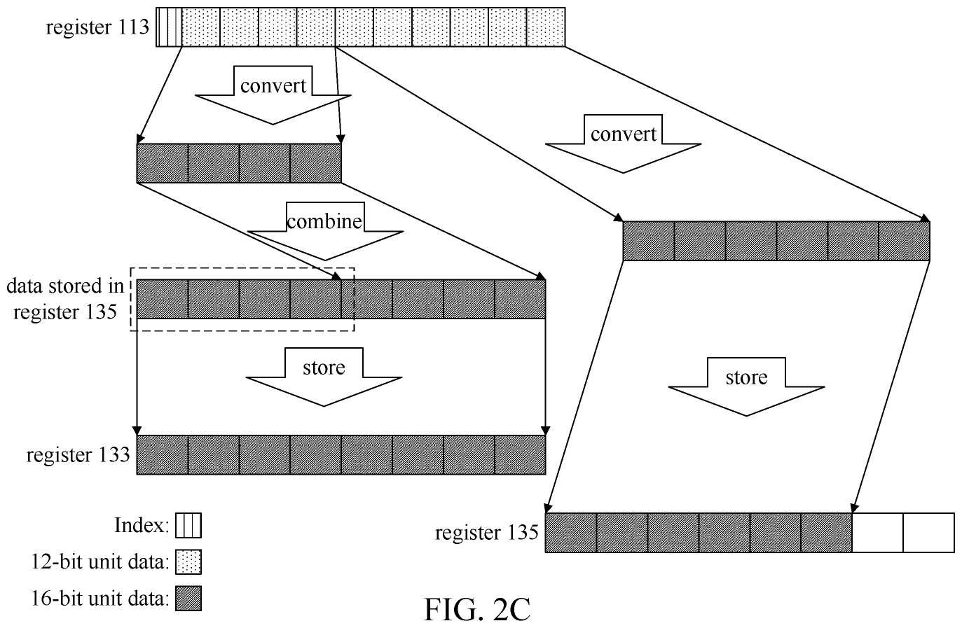

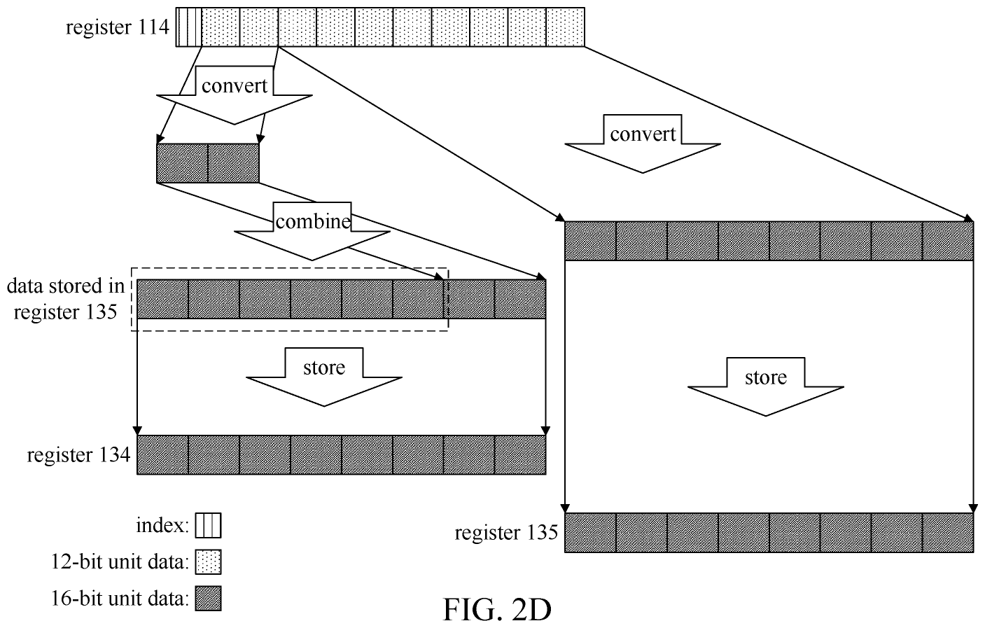

FIG. 2A to FIG. 2D show schematic diagrams of examples of data conversion and storage operations of the present application. More specifically, the first set of registers 11 are a set of data source registers used to store data in a 12-bit unit, and include four registers 111 to 114, wherein each register is a “128-bit” register. When 10 data in a 12-bit unit (a total of “120 bits”) are stored in the register, the remaining “8 bits” are used as an index of this register. The second set of registers 13 are a set of data destination registers used to store data in a 16-bit unit, and include five registers 131 to 135, wherein each register is a “128-bit” register. It should be noted that, the first set of registers 11 and the second set of registers 13 are a set of source registers and a set of destination registers used to differentiate data in different bit units. In different embodiments, the registers of the first set of registers 11 and the registers of the second set of registers 13 may be partially the same or different at least, and the registers of the first set of registers 11 and the second set of registers 13 may be used as temporary registers as needed.

As shown in FIG. 2A, in this example, the execution unit 15 converts a first part of data stored in the register 111 from a 12-bit unit to a 16-bit unit, and stores the converted first part of data in the register 131 of the second set of registers 13. In different embodiments, the register 131 of the second set of registers 13 and the register 111 of the first set of registers 11 may be the same register or different registers. Moreover, because a “128-bit” register is used to store at most 8 data in a 16-bit unit, the first part of data stored in the register 111 are first 8 data in a 12-bit unit stored in the register 111, and the converted 8 data in a 16-bit unit are stored in the register 131 of the second set of registers 13.

In this example, the execution unit 15 converts a second part of data (that is, the remaining 2 data in a 12-bit unit) stored in the register 111 from a 12-bit unit to a 16-bit unit, and stores the converted second part of data in the register 135 of the second set of registers 13. It should be noted that, in some embodiments, the operations of converting the first part of data and the second part of data stored in the register 111 by the execution unit 15 can be completed together, and the converted first part of data and converted second part of data are respectively stored in the registers 131 and 135. In some embodiments, the execution unit 15 can first convert the first part of data stored in the register 111 and store the converted first part of data in the register 131, and then convert the second part of data stored in the register 111 and store the converted second part of data in the register 135.

As shown in FIG. 2B, in this example, the execution unit 15 next converts a first part of data stored in the register 112 from a 12-bit unit to a 16-bit unit, and combines the data stored in the register 135 and the converted first part of data of the register 112. Next, the execution unit 15 stores the combined data in the register 132 of the second set of registers 13. It should be noted that, in different embodiments, the register 132 of the second set of registers 13 and the register 112 of the first set of registers 11 may be the same register or different registers. Moreover, because the register 135 stores 2 data in a 16-bit unit and a “128-bit” register is used to store at most 8 data in a 16-bit unit, the first part of data stored in the register 112 are first 6 data in a 12-bit unit in the register 111, and the data stored in the register 135 combined with the converted first part of data of the register 112 become a total of 8 data in a 16-bit unit.

In this example, the execution unit 15 converts a second part of data (that is, the remaining 4 data in a 12-bit unit) stored in the register 112 from a 12-bit unit to a 16-bit unit, and stores the converted second part of data in the register 135 of the second set of registers 13. It should be noted that, in some embodiments, the operations of converting the first part of data and the second part of data stored in the register 112 by the execution unit 15 can be completed together, and after the conversion: (1) the data stored in the register 135 and the first part of data in the register 112 are combined and stored in the register 132; and (2) the second part of data in the register 112 are stored in the register 135. In some embodiments, the execution unit 15 can first convert the first part of data stored in the register 112, and after combining the data stored in the register 135 and the converted first part of data of the register 112, store the combined data in the register 132. Then, the execution unit 15 can convert the second part of data stored in the register 112 and store the converted second part of data in the register 135.

As shown in FIG. 2C, in this example, the execution unit 15 next converts a first part of data stored in the register 113 from a 12-bit unit to a 16-bit unit, and combines the data stored in the register 135 and the converted first part of data of the register 113. Next, the execution unit 15 stores the combined data in the register 133 of the second set of registers 13. It should be noted that, in different embodiments, the register 133 of the second set of registers 13 and the register 113 of the first set of registers 11 may be the same register or different registers. Moreover, because the register 135 stores 4 data in a 16-bit unit and a “128-bit” register is used to store at most 8 data in a 16-bit unit, the first part of data stored in the register 113 are first 4 data in a 12-bit unit in the register 113, and the data stored in the register 135 combined with the converted first part of data of the register 113 become a total of 8 data in a 16-bit unit.

In this example, the execution unit 15 converts a second part of data (that is, the remaining 6 data in a 12-bit unit) stored in the register 113 from a 12-bit unit to a 16-bit unit, and stores the converted second part of data in the register 135 of the second set of registers 13. It should be noted that, in some embodiments, the operations of converting the first part of data and the second part of data stored in the register 113 by the execution unit 15 can be completed together, and after the conversion: (1) the data stored in the register 135 and the first part of data in the register 113 are stored in the register 133; and (2) the second part of data in the register 113 are stored in the register 135. In some embodiments, the execution unit 15 can first convert the first part of data stored in the register 113, and after combining the data stored in the register 135 and the converted first part of data of the register 113, store the combined data in the register 133. Then, the execution unit 15 can convert the second part of data stored in the register 113 and store the converted second part of data in the register 135.

As shown in FIG. 2D, in this example, the execution unit 15 next converts a first part of data stored in the register 114 from a 12-bit unit to a 16-bit unit, and combines the data stored in the register 135 and the converted first part of data of the register 114. Next, the execution unit 15 stores the combined data in the register 134 of the second set of registers 13. It should be noted that, in different embodiments, the register 134 of the second set of registers 13 and the register 114 of the first set of registers 11 may be the same register or different registers. Moreover, because the register 135 stores 6 data in a 16-bit unit and a “128-bit” register is used to store at most 8 data in a 16-bit unit, the first part of data stored in the register 114 are first 2 data in a 12-bit unit in the register 114, and the data stored in the register 135 combined with the converted first part of data of the register 114 become a total of 8 data in a 16-bit unit.

In this example, the execution unit 15 converts a second part of data (that is, the remaining 8 data in a 12-bit unit) stored in the register 114 from a 12-bit unit to a 16-bit unit, and stores the converted second part of data in the register 135 of the second set of registers 13. It should be noted that, in some embodiments, the operations of converting the first part of data and the second part of data stored in the register 114 by the execution unit 15 can be completed together, and after the conversion: (1) the data stored in the register 135 and the first part of data in the register 114 are combined and stored in the register 134; and (2) the second part of data in the register 114 are stored in the register 135. In some embodiments, the execution unit 15 can first convert the first part of data stored in the register 114, and after combining the data stored in the register 135 and the converted first part of data of the register 114, store the combined data in the register 134. Then, the execution unit 15 can convert the second part of data stored in the register 114 and store the converted second part of data in the register 135.

With the above data operation, the data in a 12-bit unit stored in the registers 111 to 114 of the first set of registers 11 are converted to the data in a 16-bit unit stored in the registers 131 to 135 of the second set of registers 13.

In some embodiments, the above operation can be completed by the instruction set below:
convert12to16 XMM1, XMM5
convert12to16 XMM2, XMM5
convert12to16 XMM3, XMM5
convert12to16 XMM4, XMM5

More specifically, “convert12to16” represents an instruction for converting data in a 12-bit unit to data in a 16-bit unit; “XMM1” is the register 111/131, and has an index “0” when used to store data in a 12-bit unit; “XMM2” is the register 112/132, and has an index “1” when used to store data in a 12-bit unit; “XMM3” is the register 113/133, and has an index “2” when used to store data in a 12-bit unit; “XMM4” is the register 114/134, and has an index “3” when used to store data in a 12-bit unit; and “XMM5” is the register 135.

After executing the instruction “convert12to16 XMM1, XMM5”, the following can be completed: (1) determining according to the index “0” of the register XMM1 for storing data in a 12-bit unit that there are 8 data in the first part of data, and 2 data in the second part of data; (2) converting the first part of data and the second part of data stored in the register XMM1 from a 12-bit unit to a 16-bit unit; (3) combining data (initially null) stored in the register XMM5 and the converted first part of data of the register XMM1, and storing the combined data back in the register XMM1; and (4) storing the converted second part of data of the register XMM1 in the register XMM5.

After executing the instruction “convert12to16 XMM2, XMM5”, the following can be completed: (1) determining according to the index “1” of the register XMM2 for storing data in a 12-bit unit that there are 6 data in the first part of data, and 4 data in the second part of data; (2) converting the first part of data and the second part of data stored in the register XMM2 from a 12-bit unit to a 16-bit unit; (3) combining data stored in the register XMM5 and the converted first part of data of the register XMM2, and storing the combined data back in the register XMM2; and (4) storing the converted second part of data of the register XMM2 in the register XMM5.

After executing the instruction “convert12to16 XMM3, XMM5”, the following can be completed: (1) determining according to the index “2” of the register XMM3 for storing data in a 12-bit unit that there are 4 data in the first part of data, and 6 data in the second part of data; (2) converting the first part of data and the second part of data stored in the register XMM3 from a 12-bit unit to a 16-bit unit; (3) combining data stored in the register XMM5 and the converted first part of data of the register XMM3, and storing the combined data back in the register XMM3; and (4) storing the converted second part of data of the register XMM3 in the register XMM5.

After executing the instruction “convert12to16 XMM4, XMM5”, the following can be completed: (1) determining according to the index “3” of the register XMM4 for storing data in a 12-bit unit that there are 2 data in the first part of data, and 8 data in the second part of data; (2) converting the first part of data and the second part of data stored in the register XMM4 from a 12-bit unit to a 16-bit unit; (3) combining data stored in the register XMM5 and the converted first part of data of the register XMM4, and storing the combined data back in the register XMM4; and (4) storing the converted second part of data of the register XMM4 in the register XMM5.

In some embodiments, the above operation can be completed by the instruction set below:
convert12to16 XMM1, XMM5, 0
convert12to16 XMM2, XMM5, 1
convert12to16 XMM3, XMM5, 2
convert12to16 XMM4, XMM5, 3

More specifically, “convert12to16” represents an instruction for converting data in a 12-bit unit to data in a 16-bit unit; “XMM1” is the register 111/131, “XMM2” is the register 112/132, “XMM3” is the register 113/133, “XMM4” is the register 114/134, and “XMM5” is the register 135.

After executing the instruction “convert12to16 XMM1, XMM5, 0”, the following can be completed: (1) determining according to the parameter “0” that there are 8 data in the first part of data, and 2 data in the second part of data; (2) converting the first part of data and the second part of data stored in the register XMM1 from a 12-bit unit to a 16-bit unit; (3) combining data (initially null) stored in the register XMM5 and the converted first part of data of the register XMM1, and storing the combined data back in the register XMM1; and (4) storing the converted second part of data of the register XMM1 in the register)(MIMS.

After executing the instruction “convert12to16 XMM2, XMM5, 1”, the following can be completed: (1) determining according to the parameter “1” that there are 6 data in the first part of data, and 4 data in the second part of data; (2) converting the first part of data and the second part of data stored in the register XMM2 from a 12-bit unit to a 16-bit unit; (3) combining data stored in the register XMM5 and the converted first part of data of the register XMM2, and storing the combined data back in the register XMM2; and (4) storing the converted second part of data of the register XMM2 in the register)(MIMS.

After executing the instruction “convert12to16 XMM3, XMM5, 2”, the following can be completed: (1) determining according to the parameter “2” that there are 4 data in the first part of data, and 6 data in the second part of data; (2) converting the first part of data and the second part of data stored in the register XMM3 from a 12-bit unit to a 16-bit unit; (3) combining data stored in the register XMM5 and the converted first part of data of the register XMM3, and storing the combined data back in the register XMM3; and (4) storing the converted second part of data of the register XMM3 in the register)(MIMS.

After executing the instruction “convert12to16 XMM4, XMM5, 3”, the following can be completed: (1) determining according to the parameter “3” that there are 2 data in the first part of data, and 8 data in the second part of data; (2) converting the first part of data and the second part of data stored in the register XMM4 from a 12-bit unit to a 16-bit unit; (3) combining data stored in the register XMM5 and the converted first part of data of the register XMM4, and storing the combined data back in the register XMM4; and (4) storing the converted second part of data of the register XMM4 in the register XMM5.

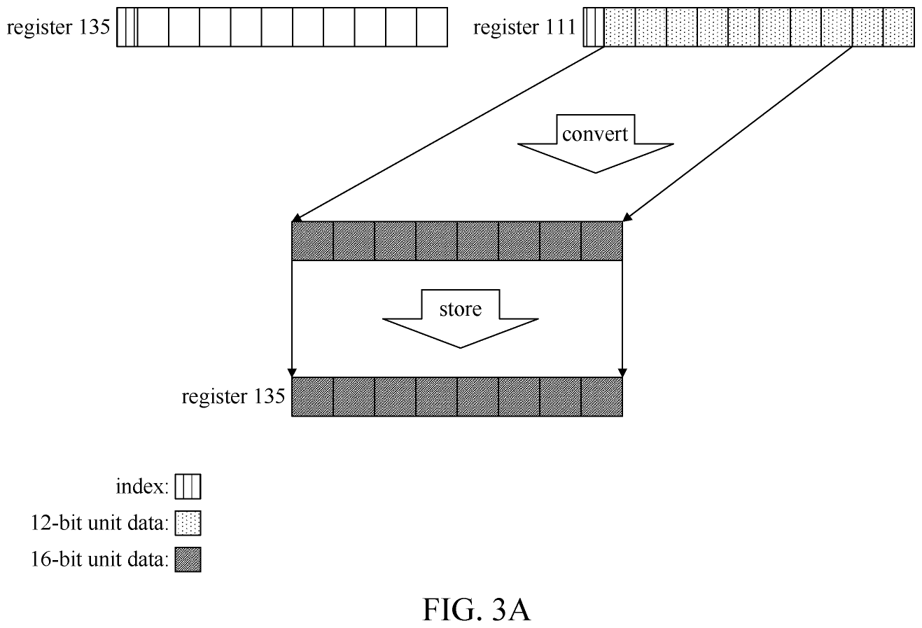

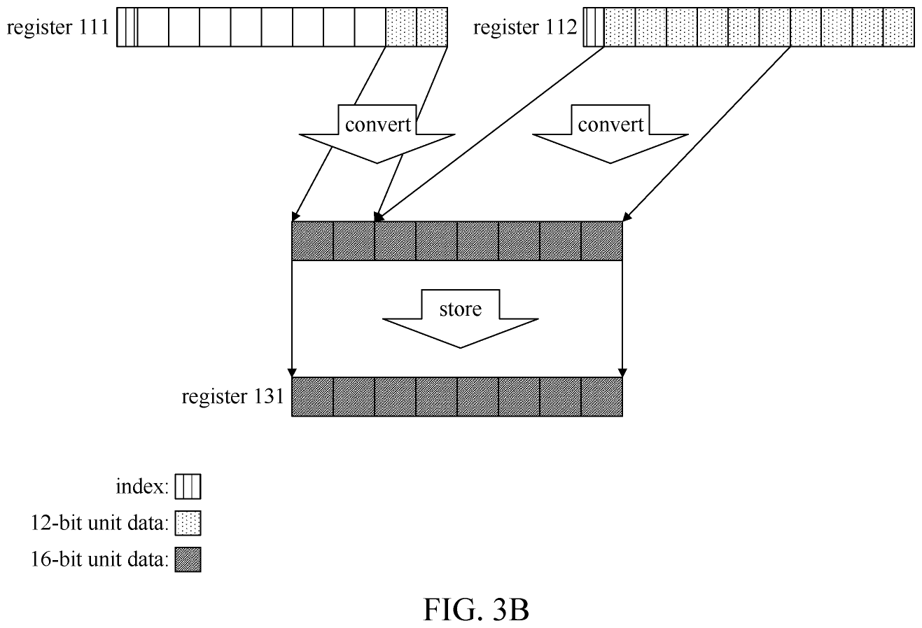

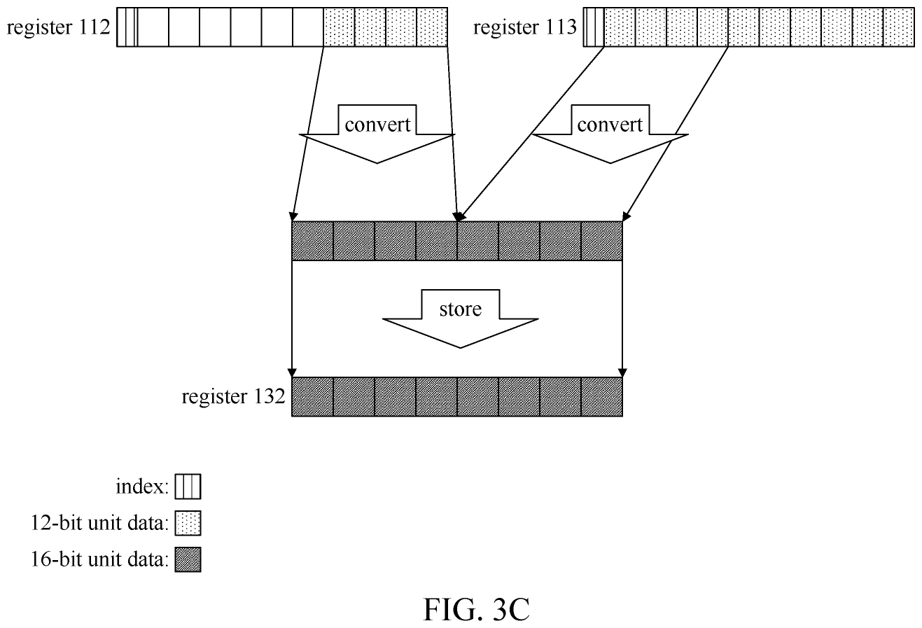

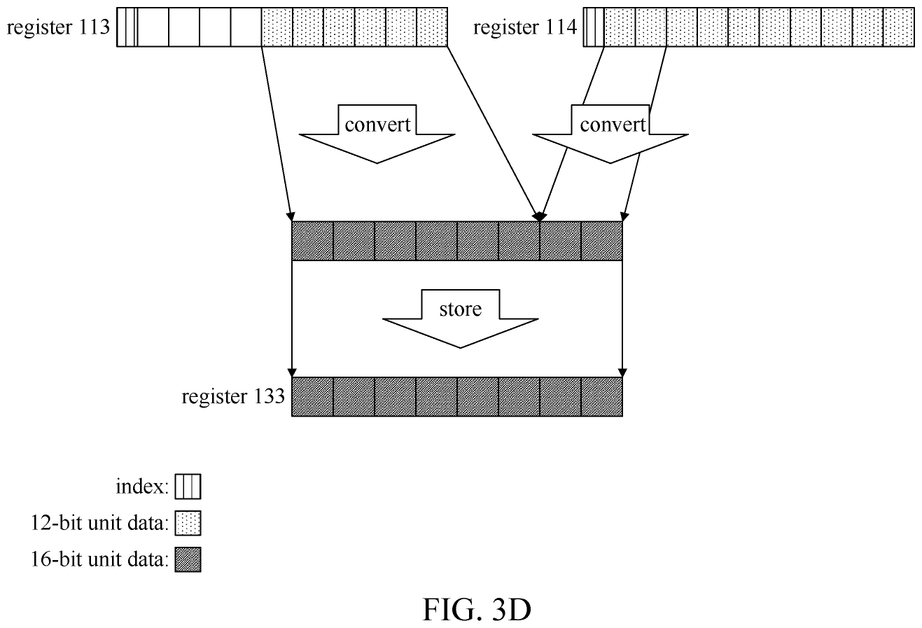

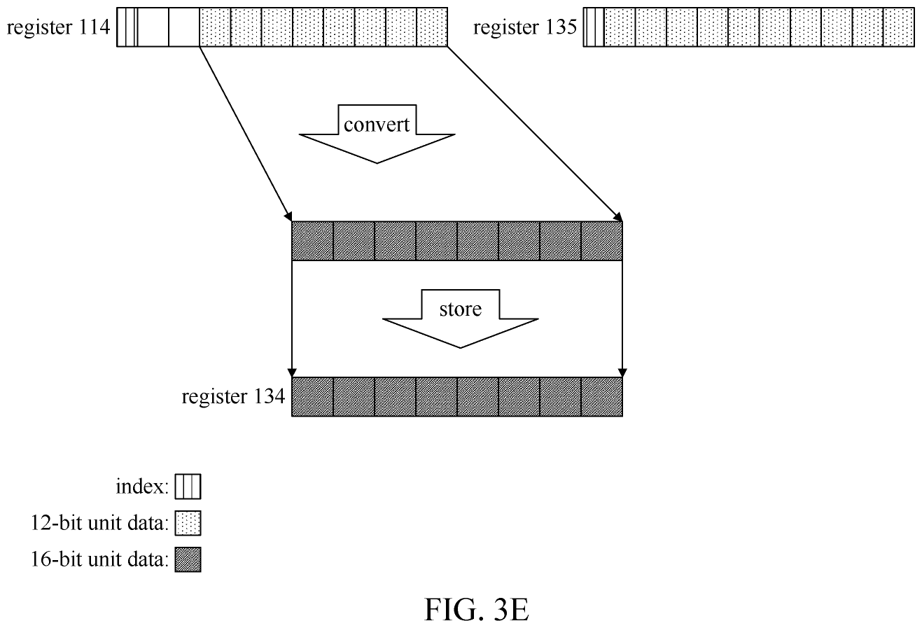

FIG. 3A to FIG. 3E show schematic diagrams of examples of data conversion and storage operations of the present application. More specifically, the first set of registers 11 are a set of data source registers used to store data in a 12-bit unit, and include four registers 111 to 114, wherein each register is a “128-bit” register. When 10 data in a 12-bit unit (a total of “120 bits”) are stored in the register, the remaining “8 bits” are used as an index of this register. The second set of registers 13 are a set of data destination registers used to store data in a 16-bit unit, and include five registers 131 to 135, wherein each register is a “128-bit” register. It should be noted that, the first set of registers 11 and the second set of registers 13 are a set of source registers and a set of destination registers used to differentiate data in different bit units. In different embodiments, the registers of the first set of registers 11 and the registers of the second set of registers 13 may be partially the same or different at least, and the registers of the first set of registers 11 and the second set of registers 13 may be used as temporary registers as needed.

As shown in FIG. 3A, in this example, the execution unit 15 converts a first part of data stored in the register 135 and a first part of data stored in the register 111 from data in a 12-bit unit to data in a 16-bit unit, and stores the converted data into the register 135. It should be noted that, the execution unit 15 fetches a total of 8 data from the register 135 and the register 111. In this example, the execution unit 15 fetches 8 data from the register 111, and fetches 0 data from the register 135.

As shown in FIG. 3B, in this example, the execution unit 15 next converts a first part of data stored in the register 111 and a first part of data stored in the register 112 from data in a 12-bit unit to data in a 16-bit unit, and stores the converted data in the register 131. It should be noted that, in different embodiments, the register 131 of the second set of registers 13 and the register 111 of the first set of registers 11 may be the same register or different registers. Moreover, the execution unit 15 fetches a total of 8 data from the register 111 and the register 112. In this example, the execution unit 15 fetches 2 data from the register 111, and fetches 6 data from the register 112.

Moreover, as shown in FIG. 3C, in this example, the execution unit 15 next converts a first part of data stored in the register 112 and a first part of data stored in the register 113 from data in a 12-bit unit to data in a 16-bit unit, and stores the converted data in the register 132. It should be noted that, in different embodiments, the register 132 of the second set of registers 13 and the register 112 of the first set of registers 11 may be the same register or different registers. Moreover, the execution unit 15 fetches a total of 8 data from the register 112 and the register 113. In this example, the execution unit 15 fetches 4 data from the register 112, and fetches 4 data from the register 113.

As shown in FIG. 3D, in this example, the execution unit 15 next converts a first part of data stored in the register 113 and a first part of data stored in the register 114 from data in a 12-bit unit to data in a 16-bit unit, and stores the converted data in the register 133. It should be noted that, in different embodiments, the register 133 of the second set of registers 13 and the register 113 of the first set of registers 11 may be the same register or different registers. Moreover, the execution unit 15 fetches a total of 8 data from the register 113 and the register 114. In this example, the execution unit 15 fetches 6 data from the register 113, and fetches 2 data from the register 114.

As shown in FIG. 3E, in this example, the execution unit 15 next converts a first part of data stored in the register 114 and a first part of data stored in the register 135 from data in a 12-bit unit to data in a 16-bit unit, and stores the converted data in the register 134. It should be noted that, in different embodiments, the register 134 of the second set of registers 13 and the register 114 of the first set of registers 11 may be the same register or different registers. Moreover, the execution unit 15 fetches a total of 8 data from the register 114 and the register 135. In this example, the execution unit 15 fetches 8 data from the register 114, and fetches 0 data from the register 135.

With the above data operation, the data in a 12-bit unit stored in the registers 111 to 114 of the first set of registers 11 are converted to the data in a 16-bit unit stored in the registers 131 to 135 of the second set of registers 13.

In some embodiments, the above operation can be completed by the instruction set below:
convert12to16 XMM5, XMM1
convert12to16 XMM1, XMM2
convert12to16 XMM2, XMM3
convert12to16 XMM3, XMM4
convert12to16 XMM4, XMM5

More specifically, “convert12to16” represents an instruction for converting data in a 12-bit unit to data in a 16-bit unit; “XMM1” is the register 111/131, and has an index “3” when used to store data in a 12-bit unit; “XMM2” is the register 112/132, and has an index “2” when used to store data in a 12-bit unit; “XMM3” is the register 113/133, and has an index “1” when used to store data in a 12-bit unit; “XMM4” is the register 114/134, and has an index “0” when used to store data in a 12-bit unit; and “XMM5” is a temporary register (which may be the register 135), and has an index “4” when used to store data in a 12-bit unit.

After executing the instruction “convert12to16 XMM5, XMM1”, the following can be completed: (1) determining according to the index “4” of the register XMM5 for storing data in a 12-bit unit that the number of data fetched from the register XMM1 is twice of “4” (that is, 8), and determining that the number of data fetched from the register XMM5 is “8” (a constant parameter) minus “8” (the number of data fetched from the register XMM1) (that is, 0); (2) combining and converting the data fetched from the register XMM5 and the data fetched from the register XMM1 from a 12-bit unit to a 16-bit unit; and (3) storing the converted data in the register XMM5.

After executing the instruction “convert12to16 XMM1, XMM2”, the following can be completed: (1) determining according to the index “3” of the register XMM1 for storing data in a 12-bit unit that the number of data fetched from the register XMM2 is twice of “3” (that is, 6), and determining that the number of data fetched from the register XMM1 is “8” (a constant parameter) minus “6” (the number of data fetched from the register XMM2) (that is, 2); (2) combining and converting the data fetched from the register XMM1 and the data fetched from the register XMM2 from a 12-bit unit to a 16-bit unit; and (3) storing the converted data in the register XMM1.

After executing the instruction “convert12to16 XMM2, XMM3”, the following can be completed: (1) determining according to the index “2” of the register XMM2 for storing data in a 12-bit unit that the number of data fetched from the register XMM3 is twice of “2” (that is, 4), and determining that the number of data fetched from the register XMM2 is “8” (a constant parameter) minus “4” (the number of data fetched from the register XMM3) (that is, 4); (2) combining and converting the data fetched from the register XMM2 and the data fetched from the register XMM3 from a 12-bit unit to a 16-bit unit; and (3) storing the converted data in the register XMM2.

After executing the instruction “convert12to16 XMM3, XMM4”, the following can be completed: (1) determining according to the index “1” of the register XMM3 for storing data in a 12-bit unit that the number of data fetched from the register XMM4 is twice of “1” (that is, 2), and determining that the number of data fetched from the register XMM3 is “8” (a constant parameter) minus “2” (the number of data fetched from the register XMM4) (that is, 6); (2) combining and converting the data fetched from the register XMM3 and the data fetched from the register XMM4 from a 12-bit unit to a 16-bit unit; and (3) storing the converted data in the register XMM3.

After executing the instruction “convert12to16 XMM4, XMM5”, the following can be completed: (1) determining according to the index “0” of the register XMM4 for storing data in a 12-bit unit that the number of data fetched from the register XMM5 is twice of “0” (that is, 0), and determining that the number of data fetched from the register XMM4 is “8” (a constant parameter) minus “0” (the number of data fetched from the register XMM5) (that is, 8); (2) combining and converting the data fetched from the register XMM4 and the data fetched from the register XMM5 from a 12-bit unit to a 16-bit unit; and (3) storing the converted data in the register XMM4.

In some embodiments, the above operation can be completed by the instruction set below:
convert12to16 XMM5, XMM1, 4
convert12to16 XMM1, XMM2, 3
convert12to16 XMM2, XMM3, 2
convert12to16 XMM3, XMM4, 1
convert12to16 XMM4, XMM5, 0

More specifically, “convert12to16” represents an instruction for converting data in a 12-bit unit to data in a 16-bit unit; “XMM1” is the register 111/131, “XMM2” is the register 112/132, “XMM3” is the register 113/133, “XMM4” is the register 114/134, and “XMM5” is a temporary register (which may be the register 135).

After executing the instruction “convert12to16 XMM5, XMM1, 4”, the following can be completed: (1) determining according to the parameter “4” that the number of data fetched from the register XMM1 is twice of “4” (that is, 8), and determining that the number of data fetched from the register XMM5 is “8” (a constant parameter) minus “8” (the number of data fetched from the register XMM1) (that is, 0); (2) combining and converting the data fetched from the register XMM5 and the data fetched from the register XMM1 from a 12-bit unit to a 16-bit unit; and (3) storing the converted data in the register XMM5.

After executing the instruction “convert12to16 XMM1, XMM2, 3”, the following can be completed: (1) determining according to the parameter “3” that the number of data fetched from the register XMM2 is twice of “3” (that is, 6), and determining that the number of data fetched from the register XMM1 is “8” (a constant parameter) minus “6” (the number of data fetched from the register XMM2) (that is, 2); (2) combining and converting the data fetched from the register XMM1 and the data fetched from the register XMM2 from a 12-bit unit to a 16-bit unit; and (3) storing the converted data in the register XMM1.

After executing the instruction “convert12to16 XMM2, XMM3, 2”, the following can be completed: (1) determining according to the parameter “2” that the number of data fetched from the register XMM3 is twice of “2” (that is, 4), and determining that the number of data fetched from the register XMM2 is “8” (a constant parameter) minus “4” (the number of data fetched from the register XMM3) (that is, 4); (2) combining and converting the data fetched from the register XMM2 and the data fetched from the register XMM3 from a 12-bit unit to a 16-bit unit; and (3) storing the converted data in the register XMM2.

After executing the instruction “convert12to16 XMM3, XMM4, 1”, the following can be completed: (1) determining according to the parameter “1” that the number of data fetched from the register XMM4 is twice of “1” (that is, 2), and determining that the number of data fetched from the register XMM3 is “8” (a constant parameter) minus “2” (the number of data fetched from the register XMM4) (that is, 6); (2) combining and converting the data fetched from the register XMM3 and the data fetched from the register XMM4 from a 12-bit unit to a 16-bit unit; and (3) storing the converted data in the register XMM3.

After executing the instruction “convert12to16 XMM4, XMM5, 0”, the following can be completed: (1) determining according to the parameter “0” that the number of data fetched from the register XMM5 is twice of “0” (that is, 0), and determining that the number of data fetched from the register XMM4 is “8” (a constant parameter) minus “0” (the number of data fetched from the register XMM5) (that is, 8); (2) combining and converting the data fetched from the register XMM4 and the data fetched from the register XMM5 from a 12-bit unit to a 16-bit unit; and (3) storing the converted data in the register XMM4.

It should be noted that, in the various above examples of “128-bit” registers and converting data from a 12-bit unit to data in a 16-bit unit, the data operation is fundamentally carried out for 8 data (for example, converting first 8 data in a 12-bit unit stored in a register into 8 data in a 16-bit unit, combining the data of two registers into a total of 8 data in a 16-bit unit, and fetching a total of 8 data in a 12-bit unit from two registers). However, these examples are not to be construed as a limitation to the implementation forms of the present application. On the basis of the disclosure of the present application, it would be easy for a person skilled in the art to understand that there are different numbers of data operations in different circumstances. For example, assume registers are all “256-bit” registers and data in a 12-bit unit are converted to data in a 14-bit unit. Because a “256-bit” register stores at most 18 data in a 14-bit unit, the number of data operations are fundamentally 18 (for example, converting first 18 data of a register in a 12-bit unit into 18 data in a 14-bit, combining data of two registers into a total of 18 data in a 14-bit unit, and fetching a total of 18 data in a 12-bit unit from the two registers). In brief, the number of data operations is fundamentally an integer based on (the capacity of registers/the high bit unit).

In some embodiments, registers that store the same type of data (for example, data in a 10-bit unit, data in a 12-bit unit or data in a 14-bit unit) can perform corresponding data calculations through calculation instructions (for example, basic arithmetic calculation instructions ADD, SUB, MUL and DIV, or logic operation instructions AND, OR and XOR).

In some embodiments, the above data conversion and calculation operations can be completed by an instruction set extension, which is suitable for data in a predetermined bit unit (for example, a bit unit that is not a power of 2, such as 10-bit, 12-bit or 14-bit), and the execution unit 15 of the processor 1 of the present application is capable of executing the instruction set extension. More specifically, the instruction set extension includes: (1) at least one calculation instruction (for example, basic arithmetic calculation instructions ADD, SUB, MUL and DIV, or logic operation instructions AND, OR and XOR) that is used to perform an arithmetic calculation or a logic operation on data stored in a specific set of registers, wherein the data stored in the specific set of registers are stored in the predetermined bit unit; and (2) multiple conversion instructions (for example, the multiple conversion instructions in the examples of the above embodiments) that are used to convert data of the other set of registers from the predetermined bit unit to another bit unit.

In some embodiments, the type of the above processor 1 may include processors such as central processing units (CPU), graphics processing units (GPU), micro control units (MCU), digital signal processors (DPS), microprocessing units (MPU) and accelerated processing units (APU), which have various signal processing circuits and sets of registers and are capable of executing related instructions. It should be noted that the implementation forms of the processor of the present application are not limited to the above examples.

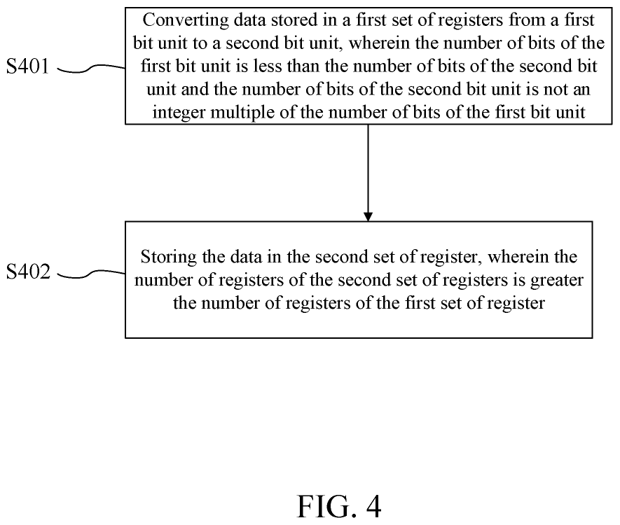

A data operation method for a processor is further provided according to some embodiments of the present application. FIG. 4 shows a flowchart of the data operation method. The data operation method according to these embodiments is implemented by a processor (for example, the processor 1 in the above embodiment), with the details of the steps of the method as described below. First of all, step S401 is performed to convert data stored in a first set of registers from a first bit unit to a second bit unit, wherein the number of bits of the first bit unit is less than the number of bits of the second bit unit and the number of bits of the second bit unit is not an integer multiple of the number of bits of the first bit unit. Step S402 is performed to store the data in the second set of registers, wherein the number of registers of the second set of registers is greater than the number of registers of the first set of registers.

In some embodiments, step S401 may further include: (1) converting a first part of data stored in a first register of the first set of registers from the first unit to the second bit unit, and/or (2) converting a second part of data in the first register of the first set of registers from the first bit unit to the second bit unit. In some embodiments, step S402 may further include: (1) storing the first part of data in the first register of the first set of registers in the first register of the second set of registers; and/or (2) storing the second part of data in the first register of the first set of registers in a second register of the second set of registers.

It should be noted that, in different embodiments, the execution details of step S401 and step S402 may be adjusted. In some embodiments, after performing (1) of step S401, (1) of step S402 may be performed subsequently, and then (2) of step S401 may then be performed, further followed by (2) of step S402. In some embodiments, (1) and (2) of step S401 are performed and completed together, and then (1) and (2) of step S402 are performed.

In some embodiments, step S401 may further include: (3) converting a first part of data stored in a second register of the first set of registers from the first bit unit to the second bit unit, and/or (4) converting a second part of data in the second register of the first set of registers from the first bit unit to the second bit unit. In some embodiments, step S402 may further include: (3) combining data stored in the second register of the second set of registers and the first part of data in the second register of the first set of registers, and storing the combined data in a third register of the second set of registers; and/or (4) storing the second part of data in the second register of the first set of registers in the second register of the second set of registers.

It should be noted that, in different embodiments, the execution details of step S401 and step S402 may be adjusted. In some embodiment, after performing (3) of step S401, (4) of step S402 may be performed subsequently, and then (3) of step S401 may then be performed, further followed by (4) of step S402. In some embodiments, (3) and (4) of step S401 are performed and completed together, and then (3) and (4) of step S402 are performed.

With the above steps and operation details, data stored in all of the registers of the first set of registers are completely converted, and the conversion process ends.

The processor and data operation method of the present application are capable of efficiently and smoothly converting data in a low bit unit to data in a high bit unit when the high bit unit is not an integer multiple of the low bit unit.

The features of some embodiments of the present application are described in brief for a person skilled in the art to more comprehensively understand various aspects of the disclosure of the present application. On the basis of the disclosure of the present application, it would be easy for a person skilled in the art pertinent to the technical field of the present application to design or modify other processes and structures, so as to achieve the same objectives and/or the same advantages of the embodiments described herein. A person skilled in the art pertinent to the technical field of the present application would be able to understand that these equivalent implementation forms are encompassed within the spirit and scope of the disclosure of the present application, and various changes, substitution, replacements and alterations may be made without departing from the spirit and range of the disclosure of the present application.

What is claimed is:

1. A data operation method for a processor, comprising:
converting data stored in a first set of registers from a first bit unit to a second bit unit, wherein the number of bits of the first bit unit is less than the number of bits of the second bit unit and the number of bits of the second bit unit is not an integer multiple of the number of bits of the first bit unit; and
storing the data in the second set of registers, wherein the number of registers of the second set of registers is greater than the number of registers of the first set of registers.

2. The data operation method according to claim 1, wherein the step of converting the data stored in the first set of registers from the first bit unit to the second bit unit further comprises:
converting a first part of data stored in a first register of the first set of registers from the first bit unit to the second bit unit;
wherein the step of storing the data in the second set of registers further comprises:
storing the first part of data in the first register of the first set of registers in a first register of the second set of registers.

3. The data operation method according to claim 2, wherein the first register of the first set of registers and the first register of the second set of registers are the same register.

4. The data operation method according to claim 2, wherein the step of converting the data stored in the first set of registers from the first bit unit to the second bit unit further comprises:
converting a second part of data stored in the first register of the first set of registers from the first bit unit to the second bit unit;
wherein the step of storing the data in the second set of registers further comprises:
storing the second part of data in the first register of the first set of registers in a second register of the second set of registers.

5. The data operation method according to claim 4, wherein the step of converting the data stored in the first set of registers from the first bit unit to the second bit unit further comprises:
converting a first part of data stored in a second register of the first set of registers from the first bit unit to the second bit unit;
wherein the step of storing the data in the second set of registers further comprises:
combining data stored in the second register of the second set of registers and the first part of data in the second register of the first set of registers, and storing the combined data in a third register of the second set of registers.

6. The data operation method according to claim 5, wherein the second register of the first set of registers and the third register of the second set of registers are the same register or different registers.

7. The data operation method according to claim 5, wherein the step of converting the data stored in the first set of registers from the first bit unit to the second bit unit further comprises:
converting a second part of data in the second register of the first set of registers from the first bit unit to the second bit unit;
wherein the step of storing the data in the second set of registers further comprises:
storing the second part of data in the second register of the first set of registers in the second register of the second set of registers.

8. The data operation method according to claim 2, wherein registers of the first set of registers store a register index.

9. The data operation method according to claim 8, wherein a length of the first part of data in the first register of the first set of registers is determined based on the register index of the first register of the first set of registers.

10. The data operation method according to claim 1, wherein the first bit unit comprises 8 bits, 10 bits, 12 bits or 14 bits, and the second bit unit comprises 10 bits, 12 bits, 14 bits, 16 bits, 32 bits or 64 bits.

11. A processor, comprising:
a first set of registers;
a second set of registers;
an execution unit, electrically connected to the first set of registers and the second set of registers, and configured to:
convert data stored in a first set of registers from a first bit unit to a second bit unit, wherein the number of bits of the first bit unit is less than the number of bits of the second bit unit and the number of bits of the second bit unit is not an integer multiple of the number of bits of the first bit unit; and
store the data in the second set of registers, wherein the number of registers of the second set of registers is greater than the number of registers of the first set of registers.

12. The processor according to claim 11, wherein the step of the execution unit converting the data stored in the first set of registers from the first bit unit to the second bit unit further comprises:
converting a first part of data stored in a first register of the first set of registers from the first bit unit to the second bit unit;
wherein the step of the execution unit storing the data in the second set of registers further comprises:
storing the first part of data in the first register of the first set of registers in a first register of the second set of registers.

13. The processor according to claim 12, wherein the first register of the first set of registers and the first register of the second set of registers are the same.

14. The processor according to claim 12, wherein the step of the execution unit converting the data stored in the first set of registers from the first bit unit to the second bit unit further comprises:
converting a second part of data stored in the first register of the first set of registers from the first bit unit to the second bit unit;
wherein the step of the execution unit storing the data in the second set of registers further comprises:
storing the second part of data in the first register of the first set of registers in a second register of the second set of registers.

15. The processor according to claim 14, wherein the step of the execution unit converting the data stored in the first set of registers from the first bit unit to the second bit unit further comprises:
converting a first part of data stored in a second register of the first set of registers from the first bit unit to the second bit unit;
wherein the step of the execution unit storing the data in the second set of registers further comprises:
combining data stored in the second register of the second set of registers and the first part of data in the second register of the first set of registers, and storing the combined data in a third register of the second set of registers.

16. The processor according to claim 15, wherein the second register of the first set of registers and the third register of the second set of registers are the same register or different registers.

17. The processor according to claim 15, wherein the step of the execution unit converting the data stored in the first set of registers from the first bit unit to the second bit unit further comprises:
converting a second part of data in the second register of the first set of registers from the first bit unit to the second bit unit;
wherein the step of the execution unit storing the data in the second set of registers further comprises:
storing the second part of data in the second register of the first set of registers in the second register of the second set of registers.

18. The processor according to claim 12, wherein registers of the first set of registers store a register index.

19. The processor according to claim 18, wherein a length of the first part of data in the first register of the first set of registers is determined based on the register index of the first register of the first set of registers.

20. A processor, comprising:
an execution unit, configured to:
execute at least one computer instruction of an instruction set to perform arithmetic calculations or logic operations on data in a first set of registers, wherein the data in the first set of registers are stored in a first bit unit; and
execute a plurality of conversion instructions of the instruction set to convert data in a second set of registers from the first bit unit to a second bit unit;
wherein the first bit unit comprises 10 bits, 12 bits or 14 bits.
